(19) United States
(12) Patent Application Publication
(10) Pub. No.: US 2011/0016151 A1
(43) Pub. Date: Jan. 20, 2011

(54) Method and apparatus for privilege control in docbase management system

(76) Inventor: Donglin Wang, Beijing (CN)

Correspondence Address: Goodwin Procter LLP;Attn: Patent Administrator, 135 Commonwealth Drive, Menlo Park, CA, 94025-1105, US

(21) Appl. No.: 12/884,903

(22) Filed: Sep. 17, 2010

Related U.S. Application Data
(63) Continuation of application No. PCT/CN2009/070439, filed on Jan. 12, 2009.

(30) Foreign Application Priority Data
Mar. 18, 2008 (CN) 200810102153.1

(51) Int. Cl. G06F 17/30

(52) U.S. Cl. 707/783; 707/E17.044

(57) ABSTRACT

The present invention discloses a method and apparatus for privilege control in a docbase management system to provide comprehensive privilege control with fine granularity. Document data stored in the docbase management system includes at least one document data object, and each document object supports at least one privilege. When granting a privilege to a role on a document data object, a set of privilege is selected from the at least one privilege supported by the document data object, and the selected set of privilege is granted to the role as the privilege of the role on the document data object. When the role is to perform an operation on the document data object, the operation of the role on the document data object is controlled according to the set of privilege of the role on the document data object.

### CROSS-REFERENCE TO RELATED APPLICATIONS

This application is a continuation of PCT/CN2009/070439 filed Jan. 12, 2009 which claims the benefit of CN 200810102153.1filed Mar. 18, 2008, both of which applications are fully incorporated herein by reference.

### FIELD OF THE INVENTION

The present invention relates to a docbase management system, and more particularly, to a method and apparatus for privilege control in a docbase management system.

### BACKGROUND OF THE INVENTION

When performing document management and control utilizing privileges in current document privilege control techniques, the following steps are generally included:

1, setting a privilege for a document;

2, inquiring the privilege set for the document according to a request of a user, determining whether the request should be allowed, if the request is allowed, performing corresponding operations; otherwise, rejecting the request.

In the above procedure, the following basic privileges can be implemented, including viewing the title, reading and deleting and so on. But this is far from meeting the increasing requirements of users.

In existing document privilege control techniques including techniques for controlling a docbase management system, application software may using a certain role to log in the docbase management system. If the role has a read privilege, the application software can save the document in a hard disk. Then a user logging in using the role not only can read the document but also can perform other operations such as editing and printing on the document. The user is a concept used in the application software, whereas the role is a concept used in the docbase management system. One user may correspond to multiple roles.

In view of the above, when a role obtains a read privilege, at the same time it also obtains privileges including editing and printing. However, in practical document management, some document may be of great importance, it may be desirable to allow all roles to read the document but not to allow all the roles to perform operations such as making modifications to the document.

With the continuous development of information technologies, a document storage system may store a large number of documents. Various clients may search and view the documents stored in the document storage system via networks. Due to the varieties of clients and users, existing document privilege control technique can no longer adapt to ever emerging new types of documents and meet continuously changing requirements of users. Therefore, there is a need for a privilege control technique which is able to provide functions regarding arrangement, management, security, presence and storage for the large number of documents and provide diversified privilege control.

### SUMMARY OF THE INVENTION

Embodiments of the present invention provide a method and an apparatus for privilege control in a docbase management system, so as to provide comprehensive privilege control with fine granularity.

According to an embodiment of the present invention, a method for privilege control in a docbase management system is provided, where document data stored in the docbase management system consists of at least one document data object, and each document data object supports a privilege. The method includes:

selecting a set of privilege from the at least one privilege supported by the document data object when granting a privilege on a document data object to a role, granting the set of privilege selected to the role as the privilege of the role on the document data object; and

when the role is to perform an operation on the document data object, controlling the operation of the role on the document data object according to the set of privilege granted to the role on the document data object;

wherein different document data objects support the same or different privileges.

According to another embodiment of the present invention, an apparatus for privilege control in a docbase management system is provided. The apparatus is applied to the docbase management system where document data in the docbase management system consists of at least one document data object. The apparatus includes:

a first module, adapted to set at least one privilege for a document data object which is supported by the document data object, wherein, different document data objects support the same or different privileges;

a second module, adapted to select a set of privilege from the at least one privilege set by the first module for the document data object and supported by the document data object, and grant the set of privilege selected as the privilege to the role on the document data object; and a third module, adapted to control, when the role is to perform an operation on the document data object, the operation of the role on the document data object according to the set of privilege granted by the second module to the role on the document data object.

In embodiments of the present invention, the document data stored in the docbase management system consists of at least one document data object and each document data object supports at least one privilege. Then a set of privilege is granted to each role on each document data object. Thus, according to the sets of privilege granted to the role for different document data objects, the docbase management system is able to control operations of the role on the document data objects. It can be seen that through the method and apparatus provided by the embodiments of the present invention, privileges on document data can be fully controlled with fine granularity. Therefore privilege management on document data can be enhanced.

### BRIEF DESCRIPTION OF THE DRAWINGS

FIG. 1 is a flowchart illustrating a general method for privilege control in a docbase management system according to an embodiment of the present invention.

FIG. 2 shows an exemplary tree structure of document data according to an embodiment of the present invention.

FIG. 3 is a flowchart illustrating a detailed method for privilege control in a docbase management system according to an embodiment of the present invention.

FIG. 4 is a schematic illustrating a structure of an apparatus for privilege control in a docbase management system according to an embodiment of the present invention.

### DETAILED DESCRIPTION OF THE INVENTION

The present invention will be described in detail hereinafter with reference to accompanying drawings and embodiments to make the technical solution and merits therein clearer.

In embodiments of the present invention, document data stored in the docbase management system has a tree structure which contains at least one node object. The document data may be disassembled into multiple document data objects. Types and the range of privileges controlled can be increased by setting privilege types supported by each document data object. In the docbase management system, fine-granularity control over various operations on the document data can be implemented by granting a privilege on each document data object to each role and controlling operations performed by the role on document data objects according to privileges granted to the role on different document data objects.

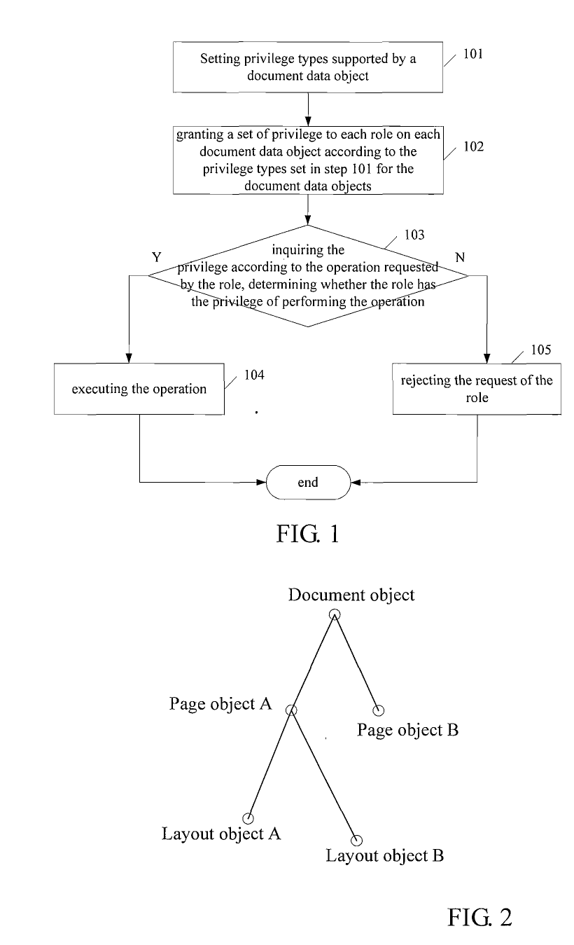

FIG. 1 is a flowchart illustrating a flowchart of a general method for privilege control in a docbase management system according to an embodiment of the present invention. The document data in the docbase management system is stored as a tree structure which includes at least one node object and each node object represents one document data object. As shown in FIG. 1, the method may include the steps as follows.

In step 101, privilege types supported by (applicable to) a document data object are set. Since the document data is stored as the tree structure including at least one node object, setting privilege types supported by a document data object may include: setting privilege types supported by each node object in the tree structure of the document data. In addition, the privilege types may be referred to as privileges in practice, especially referred to as privileges supported by a document data object but do not refer to privileges granted to a role. FIG. 2 shows an exemplary tree structure of the document data. As shown in FIG. 2, the document data is a document file, and the document file includes two pages and one of the pages includes two layout objects. Thus, the root node of the tree structure is the document object, and the document object includes two sub-node objects, denoted as page object A and page object B respectively. The page object A includes two sub-node objects, respectively denoted as layout object A and layout object B. The page object A and the page object B are both page objects, thus are node objects with the same node type. Similarly, the layout object A and the layout object B are both layout objects, and are node objects with the same node type. Suppose the privileges supported by the document object include: a privilege of viewing a title and a privilege of modifying the title. When granting a privilege to role 1 on the document object, anyone or any combination of the privileges supported by the document object (i.e. the privilege of viewing the title and/or the privilege of modifying the title) can be granted to role 1.

Herein, information related to the privilege types supported by each node object may be directly stored in the node object, or stored independently as a sub-object of the node object. Or, a relationship which associates each node object with the privilege types supported by the node object can be stored in a database or in a privilege file.

In step 102, a privilege on each document data object is granted to each role according to the privilege types set for the document data objects in step 101.

The detailed process may include: selecting at least one privilege types from among all the privileges supported by the document data objects in step 101 for different roles, and granting the selected privilege to the role as the privilege of the role on the document data object.

In step 103, the docbase management system receives an operation request from a role, determines whether the role has the privilege of performing an operation specified in the operation request according to the privilege granted to the role; if the role has the privilege of performing the operation specified in the operation request, step 104 is performed; otherwise, step 105 is performed.

In step 104, the operation is performed and the process is ended.

In step 105, the operation request of the role is rejected and the process is ended.

The step 103 to step 105 describe a detailed procedure of the docbase management system controlling operations of the role according to the privilege granted to the role for each document data object.

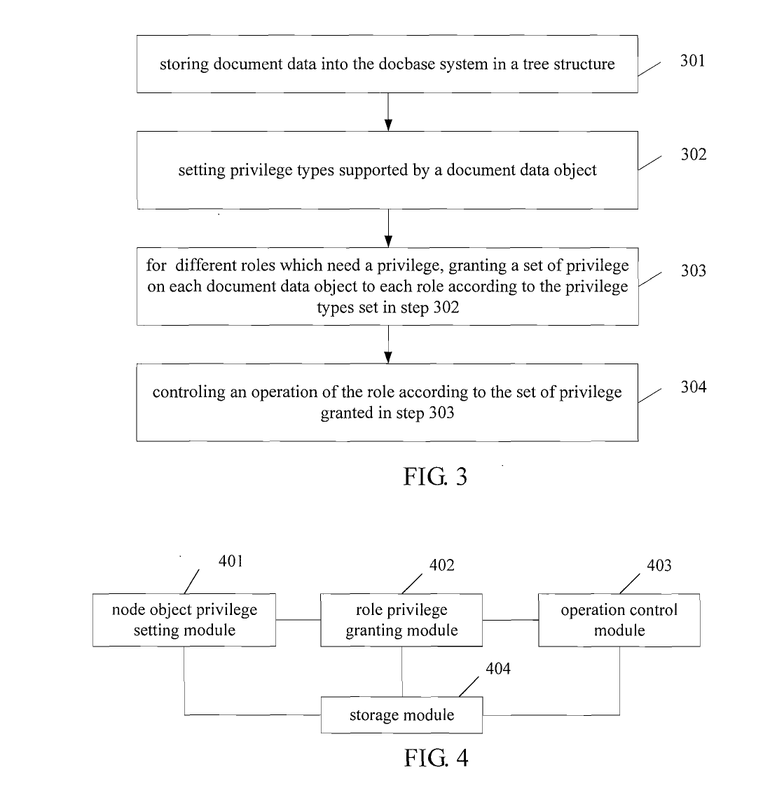

Then, a network-based docbase management system is taken as an example for describing a detailed implementation of the present invention. The docbase management system includes a client and a server. FIG. 3 is a flowchart illustrating a privilege implementation method in the docbase management system according to an embodiment of the present invention. As shown in FIG. 3, the method may include the steps as follows.

In step 301, document data is stored in the docbase management system as a tree structure. The tree structure includes at least one node object, and each node object represents a document data object. Specifically, the tree structure may include the following node types from root to leaves: docbase, document set, document, page, layer, object stream and object. The tree structure of the docbase management system may not include all the above node object types. One or more node types may be omitted in different situations. For example, the docbase management system may convert documents into a uniform format. The conversion may be performed at the client or at the server. The server stores the converted documents in different categories according to document sets the converted documents belong to. A document set is composed of multiple documents. Various manners may be adopted for managing relationships between the documents and the document sets, e.g., by utilizing the directory managing function of a file system in an operating system, or by utilizing a relationship database.

In embodiments of the present invention, the system may also select whether to save a source file, i.e. an original document, corresponding to each node object in the tree structure.

When storing a document in the docbase management system, to ensure security of the document, the document may be encrypted before being stored in the docbase management system.

In step 302, privilege types supported by the document data object are set.

In this step, for each document data object, privilege types supported by the document data object are set. The detailed process may be as follows: setting privileges supported by each node object corresponding to each document data object in the tree structure. Specifically, the setting operation may be performed during development of a docbase product or during installation of the docbase management system, or at any time according to an administrator's instruction. The privilege types supported by each document data object may be set according to configuration data of the docbase management system, or according to a user's selection, or a combination of the two manners. Hereinafter, the tree structure shown in FIG. 2 will be taken as an example for describing the setting of the privilege types for each document data object according to a user's selection. For example, during development of the docbase product, a read privilege, a write privilege, a privilege of adding a layout object and a privilege of adding a layer object are developed for each page object. The docbase management system may also provide a selection entry for the user. According to the user's selection, the write privilege is screened for page object A, and the read privilege, the write privilege and the privilege of adding a layout object are screened for page object B. As such, the privileges supported by page object A will include the read privilege, the privilege of adding a layout object and the privilege of adding a layer object, while the privilege supported by page object B will include the privilege of adding a layer object.

Take the tree structure mentioned in step 301 as an example, the privilege types set for the node objects at each level may specifically include:

1. privilege types supported by a docbase may include anyone or any combination of the following:

a, a privilege of adding a document set, denoting whether it is allowed to add a document set in the docbase;

b, a re-license privilege, denoting whether it is allowed to license a privilege on the docbase to another role;

c, a bereave privilege, denoting whether it is allowed to withdraw a granted privilege on the docbase;

2. privilege types supported by a document set may include anyone or any combination of the following:

a, a privilege of viewing the title, denoting whether it is allowed to view the title of the document set;

b, a privilege of viewing granting, denoting whether it is allowed to view the privileges granted on the document set;

c, a privilege of submitting a document, denoting whether it is allowed to submit a document to the document set;

d, a bereave privilege, denoting whether it is allowed to bereave a privilege granted to the document set;

e, a re-license privilege, denoting whether it is allowed to license the privilege on the document set to another role;

f, a delete privilege, denoting whether it is allowed to delete the document set;

3. privilege types supported by a document may include anyone or any combination of the following:

a, a privilege of viewing the title, denoting whether it is allowed to view the title of the document;

b, a privilege of viewing privileges, denoting whether it is allowed to view privilege granted on the document;

c, a privilege of viewing metadata, denoting whether it is allowed to viewing the metadata of the document;

d, a privilege of modifying elements, denoting whether it is allowed to modify the metadata of the document;

e, a bereave privilege, denoting whether it is allowed to bereave a granted privilege on the document;

f, a re-license privilege, denoting whether it is allowed to license the privilege on the document to another role;

g, a delete privilege, denoting whether it is allowed to delete the document;

h, a privilege of downloading a source file, denoting whether it is allowed to download a source file of the document;

i, a privilege of reading text, denoting whether it is allowed to read the text of the document;

j, an excerpt privilege, denoting whether it is allowed to excerpt characters in the text, e.g. export characters by utilizing a clipboard;

k, a print privilege, denoting whether it is allowed to print the document.

Among the above privileges supported by the document, privileges h-k are privileges for operations on document data. The implementations of the excerpt privilege and the print privilege are different from those of other privileges and will be described in detail later.

4. Privilege types supported by a page may include anyone or any combination of the following

a, a privilege of viewing granted privileges: denoting whether it is allowed to view privilege granted on the page;

b, a privilege of adding a layer, denoting whether it is allowed to add a layer for the page;

c, a privilege of configuring an attribute, denoting whether it is allowed to configure an attribute for the page; the privilege may be divided further into sub-privileges regarding attributes such as size, portrait or landscape orientation, page margin, etc.;

d, a delete privilege, denoting whether it is allowed to delete the page;

e, a re-license privilege, denoting whether it is allowed to license the privilege on the page to another role;

f, a bereave privilege, denoting whether it is allowed to bereave a granted page privilege.

5. Privilege types supported by a layer may include anyone or any combination of the following

a, a privilege of viewing granted privileges, denoting whether it is allowed to view privilege granted on the layer;

b, a privilege of adding an object stream, denoting whether it is allowed to add an object stream on the layer;

c, a privilege of configuring an attribute, denoting whether it is allowed to configure an attribute for the layer, wherein the privilege may be divided further into sub-privileges regarding attributes such as overlapping order, transparency, rotation angle, etc.;

d, a delete privilege, denoting whether it is allowed to delete the layer;

e, a re-license privilege, denoting whether it is allowed to license the privilege on the layer to another role;

f, a bereave privilege, denoting whether it is allowed to bereave a granted layer privilege.

6. Privilege types supported by an object stream may include anyone or any combination of the following

a, a privilege of viewing granted privileges, denoting whether it is allowed to view privilege granted on the object stream;

b, a privilege of adding an object, denoting whether it is allowed to add an object into the object stream;

c, a privilege of configuring an attribute, denoting whether it is allowed to configure an attribute for the object stream, wherein the privilege may be divided further into sub-privileges regarding attributes such as size, location, color, rotation angle, etc.;

d, a delete privilege, denoting whether it is allowed to delete the object stream;

e, a re-license privilege, denoting whether it is allowed to license the privilege on the object stream to another role;

f, a bereave privilege, denoting whether it is allowed to bereave a granted privilege;

g, a privilege of modifying the object stream, denoting whether it is allowed to modify the object stream.

7. Privilege types supported by an object may include anyone or any combination of the following

a, a privilege of viewing granted privileges, denoting whether it is allowed to view privilege granted on the object;

b, a privilege of configuring an attribute, denoting whether it is allowed to configure an attribute for the object, wherein the privilege may be divided further into sub-privileges regarding attributes such as size, location, color, rotation angle, title, contents, etc.;

c, a delete privilege, denoting whether it is allowed to delete the object;

d, a re-license privilege, denoting whether it is allowed to license the privilege on the object to another role;

e, a bereave privilege, denoting whether it is allowed to bereave a granted privilege;

f, a privilege of modifying the object, denoting whether it is allowed to modify the object.

The above re-license privilege actually includes two situations, one is that a role grants a privilege granted to the role on the object to another role (i.e. reserve the privilege after granting the privilege to the another role); the other is that a role transfers a privilege granted to the role on the object to another role (i.e. the privilege is no more reserved for the role after the privilege is granted to the another role). In practice, it can be configured whether to reserve the privilege after the privilege is granted to another role. The above bereave privilege also includes two situations. In the first situation, a privilege bereaved is the privilege the role re-licensed; and in the other situation, a privilege bereaved is not necessarily the privilege the role re-licensed. Therefore, it also can be configured whether the privilege to be bereaved is granted by the role.

In this embodiment, 45 privilege types of 7 node object types are listed. In practice, different node object types can be selected and other privilege types for the node object types can be set according to the needs to implement diversified management to the document data.

The above is merely exemplary description to the privilege types supported by each node object. Actually, the privilege types for each node object may be set according to the needs. And some of the above privileges may be combined into one combined privilege, e.g., the privilege of viewing object name and the privilege of viewing object attribute may be combined into one privilege. In addition, privilege types supported by a sub-object of one object may also be taken as the privilege types supported by the object, e.g. the privilege of adding a layer to a page may be taken as a privilege type of a document. In practice, the settings can be flexible according to the needs.

When setting privileges supported by each node object, privileges may be set for different node objects of the same type, and are supported by all node objects of the type. Privileges can also be set for each of node object respectively. Two node objects of the same type may support the same or different privileges. For example, privileges may be selected in batch for documents through a document set, i.e. the same document privileges will be selected for all documents in a document set.

Still taking FIG. 2 as an example, when setting privileges supported by pages, for different pages such as page object A and page object B, privileges supported by the pages can be set in uniform. Thus, page object A and page object B will support the same privilege types. Alternatively, privilege types may be set respectively for each page, which is more flexible but more complicated compared with the uniformly setting manner.

When configuring the privileges supported by each node object, it can be set in default that privileges supported by a parent node object include the privileges supported by its child node objects; or it can be set in default that the privileges supported by a child node object include the privileges supported by the parent node object of its child node object.

Relationships which associate each node object with the privileges supported by the node object may be stored in a database or in a privilege file.

For example, suppose that there are m object types, respectively denoted as O1, O2, . . . Om. For each object type Oi (1<=i<=m), ni privilege types may be defined for the object type, respectively denoted by P1, P2, . . . , Pni. When storing the privilege types, ni tuple (Oi, Pj) are generated for the object type Oi, wherein 1<=j<=ni. Each tuple is used for identify a privilege type configured for object type Oi. For all m object types, there may be Σni (1<=i<=m) tuples generated altogether.

If a database is adopted for storing the privilege types set, the Σni (1<=i<=m) tuples may be stored into one table, with each element group occupying one row. The table includes at least two columns among which two columns respectively store the object types and privilege types corresponding to the object types.

If the privilege file is adopted for storing the privilege types set, the Σni (1<=i<=m) tuples may be stored in one text file, with each element group occupying one row. In each row, the object type is firstly stored and then the privilege types are stored, and the object type and the privilege types are isolated by spaces.

In step 303, based on the privilege types set in step 302, a privilege on each document data object is granted to each role which needs a privilege.

Since different privilege types have been set for different node objects in step 302, in this step, the privileges granted to the role on each document data object are within the scope of the privilege types supported by the document data objects, i.e. the privilege granted to the role on each document data object is a subset of the privileges supported by each node object. Thus, the operation for granting the privilege to the role is completed.

When granting the privilege to the role on each document data object, the procedure may be as follows: selecting a privilege from the privileges supported by each node object corresponding to each document data object, granting the selected privilege to the role on the document data object. The privileges on different node objects of the same type can be granted to the role uniformly, i.e., granting the same privilege to the role on all node objects of the same type. But it is required that all the node objects of the same type should support the privilege granted to the role. Alternatively, a privilege on each of the node objects of the same type can be granted to the role respectively, i.e. grant a privilege to the role on different node objects of the same type respectively. Still taking FIG. 2 as an example, the tree structure has two page objects, i.e., page object A and page object B respectively. When granting privileges to a role on the page object A and the page object B, different privileges can be granted to the role on the page object A and the page object B, e.g., granting a privilege of viewing a title to the role on the page object A and granting a re-license privilege to the role on the page object B.

When granting a privilege to the role on each node object, it can be set that the role has the same privilege on all sub node objects of a node object as long as all the sub node objects of the node object support the privilege. In this step, the relationship associating the role with the privileges granted to the role on all node objects may be saved in a privilege file or stored in a database. The detailed storage manner can be obtained by referring to the manner for storing the privilege types in step 302.

In step 304, operations of the role on the document data are controlled according to the privileges granted in step 303 to the role on the document data objects.

The detailed process may include: the role sends an operation request to the docbase management system; the docbase management system inquires the privilege granted to the role, determines whether the role has the privilege of performing the operation specified in the operation request. If the role has the privilege of performing the operation specified in the operation request, the docbase management system allows the operation specified in the operation request to be performed; otherwise, the docbase management system rejects the operation request.

In the above embodiment, the detailed implementation of the present invention is described by taking the network-based docbase management system as an example. In fact, the method of the present invention is also applicable for a stand-alone docbase management system. Differences only lie in that the server and the client are located in the same physical entity.

Embodiments of the present invention also provide an apparatus for privilege control in the docbase management system. The apparatus is adopted in the docbase management system, wherein document data in the docbase management system includes at least one document data object. The document data is stored in a tree structure including at least one node object, with each node object representing one document data object. FIG. 4 is a schematic illustrating a structure of an apparatus for privilege control in the docbase management system according to an embodiment of the present invention. As shown in FIG. 4, the apparatus may include a document data object privilege setting module 401, a role privilege granting module 402 and an operation control module 403.

The document data object privilege setting module 401 is adapted to set privileges supported by each document data object.

The role privilege granting module 402 is adapted to select, when granting a privilege to a role on a document data object, at least one privilege from the privileges set by the document data object privilege setting module 401 for the document data object and supported by the document data object, and grant the at least one privilege selected to the role as the privilege of the role on the document data object.

The operation control module 403 is adapted to control, when the role is to operate on the document data object, an operation of the role on the document data according to the privilege granted by the role privilege granting module 402 to the role on the document data object.

The apparatus for privilege control in the docbase management system may further include a storage module 404, adapted to store a relationship which associates the document data object with the privilege which is set by the document data object privilege setting module 401 and supported by the document object, so that the role privilege granting module 402 may obtain the privilege supported by the document object from the relationship; and/or, adapted to store a relationship which associates the role with the privilege granted by the role privilege granting module 402 to the role on the document data object, so that the operation control module 403 may obtain the privilege of the role on the document data object from the relationship.

It can be seen from the above descriptions of the embodiments of the present invention, the present invention enriches the types of document privilege managements, realizes access control of a role over different document data objects; increases the types of privilege managements, improves the flexibility of privilege management. As such, through the method of the present invention, a docbase management system with multiple privileges is realized, and privilege management to the document is improved.

The foregoing descriptions are only preferred embodiments of this invention and are not for use in limiting the protection scope thereof. Any changes and modifications can be made by those skilled in the art without departing from the spirit of this invention and therefore should be covered within the protection scope as set by the appended claims.

1. A method for privilege control in a docbase management system, wherein document data stored in the docbase management system includes at least one document data object, and at least one privilege is supported by a document object; the method comprises:
selecting a set of privilege from the at least one privilege supported by the document data object, granting the set of privilege selected to the role as the privilege of the role on the document data object; and
when the role is to perform an operation on the document data object, controlling the operation of the role on the document data object according to the set of privilege granted to the role on the document data object;
wherein different document data objects support the same or different privileges.

2. The method of claim 1, further comprising: storing a relationship which associates the document data object with the at least one privilege supported by the document data object to obtain the at least one privilege supported by the document data object according to the relationship; and/or
storing a relationship which associates the role with the set of privilege granted to the role on the document data object to obtain the set of privilege granted to the role on the document data object according to the relationship.

3. The method of claim 2, wherein the relationship which associates the document data object with the at least one privilege supported by the document data object and/or the relationship which associates the role with the set of privilege granted to the role on the document data object is stored in a database or in a file.

4. The method of claim 2, wherein the document data is in a tree structure comprising at least one node object, and each node object in the tree structure represents a document data object.

5. The method of claim 4, wherein the at least one privilege supported by the document data object is a privilege supported by a node object corresponding to the document data object;
the step of selecting a set of privilege from the at least one privilege supported by the document data object and granting the set of privilege selected to the role as the set of privilege of the role on the document data object comprises:
selecting a set of privilege from the at least one privilege supported by the node object corresponding to the document data object, and granting the privilege selected to the role as the privilege of the role on the document data object.

6. The method of claim 5, wherein the relationship which associates the document data object with the at least one privilege supported by the document data object comprises: a relationship which associates a node object with the at least one privilege supported by the node object;
the relationship which associates the role with the set of privilege granted to the role on the document data object comprises: a relationship which associates the role with a set of privilege granted to the role on a node object; wherein
the node object is corresponding to the document data object.

7. The method of claim 5, wherein the tree structure comprises anyone or any combination of following levels of node objects in sequence: a docbase, a document set, a document, a page, a layer, an object stream and a layout object.

8. The method of claim 7, wherein the at least one privilege supported by the node object corresponding to the document data object comprises anyone or any combination of:
a privilege of viewing an attribute of the node object, a privilege of viewing a name of the node object, a privilege of modifying the name of the node object, a privilege of modifying the attribute of the node object, a privilege of granting the privilege on the node object to another role, a privilege of re-licensing the privilege on the node object to another role, a privilege of bereaving a privilege of another role on the node object, a privilege of view privilege granted on the node object, a privilege of printing information of the node object, a privilege of downloading a source file corresponding to the node object, a privilege of deleting a node object, a privilege of creating a sub-node of the node object, and a privilege of deleting a sub-node of the node object.

9. The method of claim 8, wherein if the node object corresponding to the document data object is a document or a page, the at least one privilege supported by the node object corresponding to the document data object further comprises anyone or any combination of: a privilege of reading text corresponding to the node object, a privilege of excerpting characters corresponding to the node object, and a privilege of modifying the node object.

10. The method of claim 8, wherein if the node object corresponding to the document data object is an object stream or an object, the at least one privilege supported by the node object corresponding to the document data object further comprises: a privilege of modifying the node object.

11. The method of claim 7, wherein the at least one privilege supported by the node object corresponding to the document data object further comprises: a privilege supported by a sub-node object of the node object, or a privilege supported by a parent node object of the node object.

12. The method of claim 1, wherein the at least one privilege supported by the node object corresponding to the document data object is set based on configuration data of the docbase management system; and/or is designated by an administrator when the docbase management system is installed or in operation; and/or is set based on a document data-specific privilege configured by a user when the docbase management system is installed or in operation.

13. The method of claim 5, wherein different node objects of the same type in the tree structure support the same or different privileges.

14. The method of claim 5, wherein different sets of privilege or the same set of privilege is granted to a role on different node objects of the same type in the tree structure.

15. The method of claim 5, further comprising: selecting a set of privilege uniformly for at least one sub-node object of the node object corresponding to the document data object, and granting the set of privilege to the role on the at least one document data object corresponding to the at least one sub-node object uniformly.

16. The method of claim 5, wherein controlling the operation of the role on the document data object according to the set of privilege granted to the role on the document data object comprises:
determining whether the role has a privilege of performing the operation on the document data object according to the set of privilege of the role on the document data object, if the role does not have the privilege of performing the operation on the document data object, rejecting the operation of the role on the document data object.

17. The method of claim 1, wherein, the document data stored in the dacbase management system is encrypted.

18. The method of claim 1, wherein the set of privilege selected includes zero or at least one privilege.

19. An apparatus of privilege control in a docbase management system, adopted in the docbase management system where document data includes at least one document data object, the apparatus comprises:
a first module, adapted to set at least one privilege supported by a document data object, wherein, different document data objects support the same or different privileges;
a second module, adapted to select a set of privilege from the at least one privilege set by the first module for the document data object and supported by the document data object, and grant the set of privilege selected to the role as the privilege of the role on the document data object; and
a third module, adapted to control, when the role is to perform an operation on the document data object, the operation of the role on the document data object according to the set of privilege granted by the second module to the role on the document data object.

20. The apparatus of claim 19, further comprising:
a fourth module, adapted to save a relationship which associates the document data object with the at least one privilege supported by the document data object set by the first module to enable the second module to obtain the at least one privilege supported by the document data object according to the relationship; and/or
adapted to save a relationship which associates the role with the set of privilege granted to the role on the document data object to enable the third module to obtain the set of privilege granted to the role on the document data objet according to the relationship.
